(19) United States
(12) Patent Application Publication
(10) Pub. No.: US 2007/0050485 A1
(43) Pub. Date: Mar. 1, 2007

(54) System and method for designing multi-ring communication networks

(75) Inventor: Ali Zolfaghari, San Ramon, CA (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/215,726

(22) Filed: Aug. 30, 2005

(51) Int. Cl. G06F 15/177

(52) U.S. Cl. 709/220

(57) ABSTRACT

A system and method for designing a large-scale communication network is provided. A transmission demand for communication traffic between nodes of a communication system is determined. Nodes in the communication system having special characteristics are identified to form at least one cluster of nodes. The transmission demand can be partitioned into an intra-cluster demand, an inter-adjacent cluster demand (transmission demand between adjacent clusters) and a long reach demand (between non-adjacent clusters). The collector ring can be configured to carry the intra-cluster demand and design metrics can be utilized to predict the rings performance. If the parameters are unacceptable the collector ring can be reconfigured. If the parameters are acceptable then an adjacent ring can be configured to handle cluster-to-cluster communications. The adjacent ring can be evaluated with the design metrics to determine a projected performance. The adjacent ring may accommodate a transmission demand that could not be accommodated by the collector ring. When the adjacent ring configuration does not satisfy the design parameters it can be redesigned. When the adjacent ring configuration satisfies predetermined design parameters then an express ring can be configured to carry the long reach demand and possibly a left over intra-cluster and inter-adjacent cluster demands. The express ring is evaluated and when satisfactory all rings are integrated into a final design. The final design can be reevaluated in its entirety utilizing the design metrics to provide an efficient and robust communication system design.

### FIELD OF THE DISCLOSURE

The present disclosure is generally related to communication networks and to the design of large-scale communication networks.

### BACKGROUND

The modem information highway commonly referred to as the “Internet” continues to grow and improve. Improved voice, data, and video applications continue to create a growing demand for data transport systems. Managing this unprecedented growth poses a significant challenge for service providers. At the core of most of these transmission systems are high-speed fiber optic transmission networks. A typical high volume communication system utilizes “communication rings” that circulate traffic between nodes with an efficient routing pattern. Many factors enter into the design of networks with multiple ring systems and producing a cost effective robust design poses significant challenges for designers. Factors such as cost, ease of implementation, “healability”(i.e. the ability of a system to reroute data transmissions when a failure occurs), demand fulfillment, meeting performance objectives, and efficient routing pathways should all be considered in expanding, perfecting and improving large scale communication networks. Accordingly, there is a need for a system and method that is capable of configuring high speed, high volume multi-ring communication networks.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is an illustrative example of a computer system that may be utilized to execute electronic instructions in accordance with the present disclosure;

FIG. 2 is an illustrative system block diagram of a typical computer system that may be used to execute electronic instruction in accordance with the present disclosure;

FIG. 3 illustrates and exemplary fiber connectivity map;

FIG. 4 depicts an exemplary network demand pattern;

FIG. 5 shows an exemplary communication system solution that is provided by a non-hierarchical multi-level design method; and

FIG. 6 presents a flow diagram that illustrates a method of embodying designing and analyzing a communication system utilizing a non-hierarchical, multi-level design method.

### DETAILED DESCRIPTION OF THE DRAWINGS

The following description is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by this detailed description.

There are many factors to be considered in creating or modifying a design of a high speed, high capacity communication network. Consequently, there are many design trade-offs and factors to be balanced when planning changes to such as system. For example, the type and the location of hardware, the topology of rings, direction of traffic, protection mechanisms, inter-ring connectivity nodes of the rings, redundancy, failure recovery, protection loops, projected demands, performance objective, a network survivability ratio, (indicating network's healing ability and redundancy) and budget are examples of parameters that enter into a design of such a large scale communication system. Balancing all of these considerations to produce an optimum system design is a difficult task.

As with any design problem an essential issue is the selection of a system type or methodology that can meet the minimal design requirements. Each system will typically have strengths and weaknesses and advantages and disadvantages. For example a synchronous optical network (SONET) unidirectional path switched ring, (UPSR), or a SONET bidirectional line switched ring, (BLSR) or an optical channel dedicated protection ring, (OchDPRing) or an optical channel shared protection ring, (OchSPRing) are examples of different system types each having advantages and disadvantages.

A non-hierarchical multi-ring design method (NHRDM) and system for optimizing operation of large and complex data transport networks is provided. The NHRDM utilizes a network decomposition technique to reduce a multi-ring configuration of a sophisticated large network to several smaller function specific sub-networks that can be analyzed by optimization techniques. The NHRDM minimizes inter-ring traffic and, as a result, maximizes service survivability with minimum cost. Reduction of inter-ring demand lowers the deployment costs and operational costs of the transport networks by reducing Broadband Digital Cross Connect System (BDCS) and/or Optical Cross Connect (OXC) port requirements.

Reduction of inter-ring demand also eases the need for costly dual ring interconnections and “Drop-and-Continue” interconnections between rings. The unique features described herein make the system and method superior to existing methods. By using the NHRDM, disadvantages and problems associated with current tools and methods utilized for designing complex transport networks are substantially reduced or eliminated.

One objective of the system and method disclosed herein is to determine places where “communication rings” can be formed or implemented. Breaking a large communication system into “function specific” communication rings can allow for an improved design and an improved communication network. In a particular embodiment a large-scale communication system can be analyzed by breaking the system into three basic types of function specific rings, each ring providing service for a different interest.

Function specific rings may include an inter cluster ring for “collecting data” (a C-ring), an inter-adjacent cluster ring (an A- ring) and a long reach or express ring (an E-ring). The A-ring can move data from C-ring to C-ring and the E-ring can be utilized for making long distance communication links.

In one configuration of the present disclosure, a design process is initiated by identifying nodes having unique features and creating clusters comprised of the identified nodes. The unique features may be factors such as the distance, fiber diversity, and geographic characteristic between the nodes.

Creation of a ring design can be initiated by proceeding through a “cycle.” A cycle can be considered as proposed paths connecting a sequence of nodes. A cycle may proceed from an origination node, through intermediate nodes, and back to the origination node such that no node is repeated. At this point in the process, a cycle is a set of disjoint paths and nodes that can be utilized for ring formation. The possible ring configurations can be started by considering rings formed between two nodes and then providing a ring to all of the nodes on the cycle. Once a cycle is generated, various combinations of nodes on the cycle that have active SONET Add/Drop Multiplexers (ADM) or optical ADMs (OADMs) can be utilizing to configure possible ring configurations.

In a particular embodiment C-Rings are built based on an all inclusive (i.e. an A to Z) cluster demand pattern with the goal of routing all C-ring demands (i.e. inter-cluster demands) within one ring. This objective minimizes, or attempts to avoid inter-ring traffic. When a C-ring configuration is conceived, calculations can be performed to determine design metrics indicating the anticipated performance of the conceptual C-ring. The C-rings can continually be re-configured to obtain improved design metrics. However, even if some or all of the design metrics are unsatisfactory, a portion of the inter-cluster demand can be reserved for routing on an A-ring or an E- ring in subsequent steps.

The A-Rings can then be configured to transport the inter-adjacent cluster demand, however the remaining, or reserved C-ring demand can be satisfied by an A-ring having a proper design. When a new ring is conceptually configured, the design metrics can be calculated and if any design metric is not satisfactory, the surplus demand (the excess inter-adjacent cluster demand) can be reserved for routing on the E-rings (i.e., long reach rings) in a subsequent process. E-rings are intended to carry the long distance demands between non-adjacent clusters. However, depending on the size of the network under design or analysis, E-Rings may not be required.

When the design metrics are calculated the results can compared to a set of design criteria or a predetermined range of values. The design criteria can include numbers for a ring achievable utilization, network survivability ratio (indicating healing ability), cost per routed unit demand, equipment cost, and overall network utilization. Based on these design criteria an efficient and robust large-scale communication system can be configured.

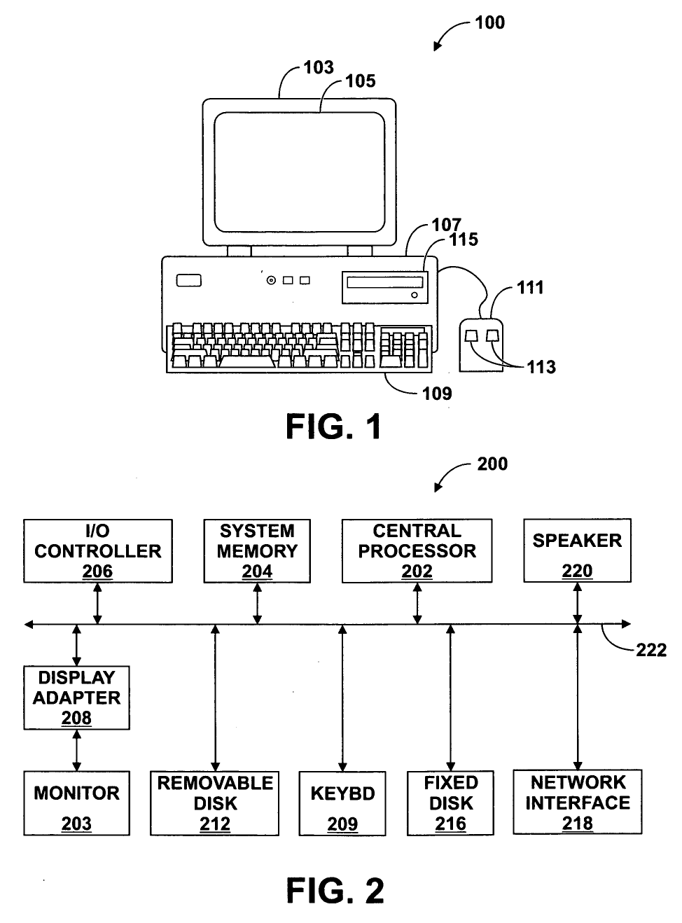

FIG. 1 illustrates an example of a computer system 100 that could be utilized to execute or implement the method described by the present disclosure. The computer system 100 may include a monitor 103, screen 105, cabinet 107, keyboard 109, and mouse 111. Mouse 111 may have one or more buttons such as mouse buttons 113. Cabinet 107 may house a CD-ROM drive 115, a system memory and a hard drive (also see FIG. 2) which may be utilized to store and retrieve software programs incorporating code or executable instructions that can implement the method of the present disclosure, data for use with the present invention, and the like. Cabinet 107 can also contain familiar computer components (not shown) such as a central processor, system memory, a hard disk, and the like.

Although a CD-ROM 117 is shown as an exemplary computer readable storage medium, other computer readable storage media including floppy disks, tape, flash memory, system memory, and hard drives may also be utilized. Whatever the form factor, the computer readable media may contain instructions that are capable of directing one or more components of system 100 to access and consider locally and/or remotely stored data, to identify a collection of nodes to design intra-cluster rings serving all intra-cluster traffic.

FIG. 2 is an illustration of an exemplary block diagram of computer system 200 that could be utilized to execute the instructions embodying the method of the present disclosure. As in FIG. 1, computer system 200 may include a monitor 203 and keyboard 209. Computer system 200 further includes subsystems such as a central processor 202, system memory 204, I/O controller 206, display adapter 208, removable disk 212 (e.g., CD-ROM drive), fixed disk 216 (e.g., hard drive), network interface 218, and speaker 220. Other computer systems suitable for use with the present invention may include additional or fewer subsystems. For example, another computer system could include more than one processor 202 (i.e., a multi-processor system) or a cache memory.

Exemplary system bus 222 provides a bus architecture of computer system 200 to facilitate component or subsystem interaction. However, these arrows are illustrative of any interconnection scheme serving to link the subsystems. For example, a local bus could be utilized to connect the central processor 202 to the system memory 204 and display adapter 208. The computer system 200 shown in FIG. 2 is but an example of a computer system suitable for use with the present disclosure. Other configurations of subsystems suitable for use with the present invention will be readily apparent to one of ordinary skill in the art.

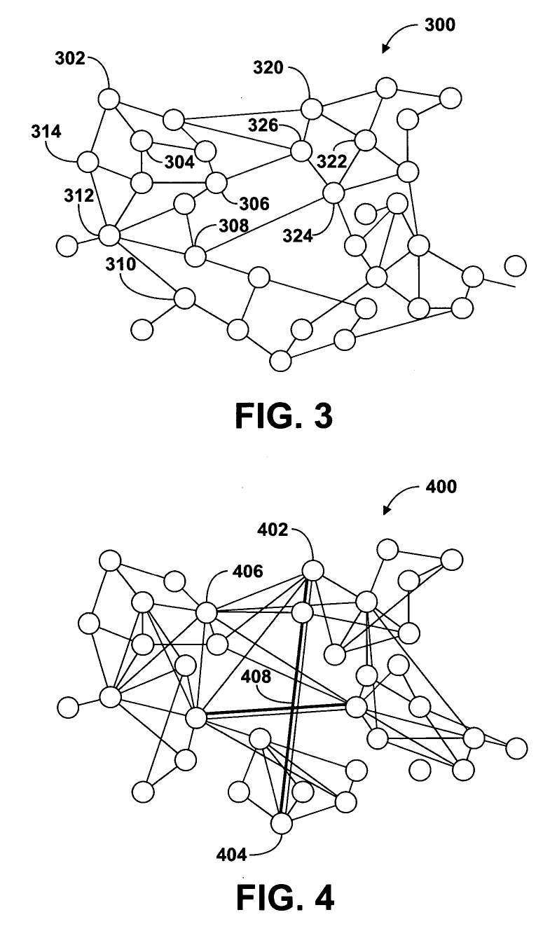

Referring to FIG. 3, an exemplary fiber connectivity map is illustrated. The circles represent nodes and the interconnecting lines illustrate fiber optic lines or Wavelength Division Multiplex (WDM) optical paths on physical optical fiber links. A node can be a central office that may have complex communication equipment such as SONET ADMs or Optical Add/Drop Multiplexers (OADMs). The exemplary map may, for example, represent a portion of a metro area network or an entire country. The network illustrated 300 may also represent an Administrative Planning Area (APA) or a Local Access and Transport Area (LATA). A LATA is typically considered a geographic region assigned to one or more telephone companies for providing communication services. The network disclosed, of course in not drawn to scale.

A demand pattern or community of interest between two nodes may be established for a first cluster of nodes 302-314 and a second cluster of nodes 320-326. Additionally, a demand pattern may be established for the inter-cluster demand between nodes locating in different clusters. For example, there may be a significant demand between nodes 308 and 324 (308 and 324 are in different clusters) and the inter-ring demand may be satisfied by a ring connecting nodes in the cluster.

FIG. 4 illustrates a demand pattern 400 for network traffic for the same or a similar network as the one described in FIG. 3. The transmission demand pattern (possibly determined from historical transmission data) can be partitioned into three discrete service categories; cluster demand, an inter-adjacent-cluster demand, and a long-reach demand. Cluster demand can be considered as the intra-cluster community of interest or demand between nodes in the cluster. Analyzing the cluster set can provide a cluster demand. The inter-adjacent cluster demand provides a community of interest between adjacent clusters, and the long-reach demand can be understood as a remaining demand to be address by the design method for satisfying a total node-to-node or “A-to-Z” demand.

A system topology can be selected for evaluation based on the A-Z demand or demand pattern. Moreover, graphic representations of the demand pattern may be created and displayed using a system like system 100 of FIG. 1. However developed, system topologies can include various types of communications technologies such as a digital signal level 3 (DS3), optical carrier level 3 (OC3), OC12, OC48, OC192 and GbE type configurations.

A high capacity demand, such as OC48, may occur between nodes 402 and 404 as illustrated by line 408. Line 408 has a bolder appearance to indicate the heavier demand between nodes 402 and 404. There may also be another high capacity demand between other nodes such as nodes 404 and 406.

The traffic demand can be determined by identifying a volume of transmissions between an originating node and a receiving node over a given period of time. This traffic demand can be independent of any actual connection between the nodes; thus, even though no point-to-point connection exists between two nodes a significant traffic demand can exist between the nodes. Depending on available data, past traffic data and growth data may be utilized to predict future traffic demand between nodes. New customers, new services, and changes to the infrastructure may also provide input to be considered when projecting traffic demand and utilizing such a prediction to configure a design.

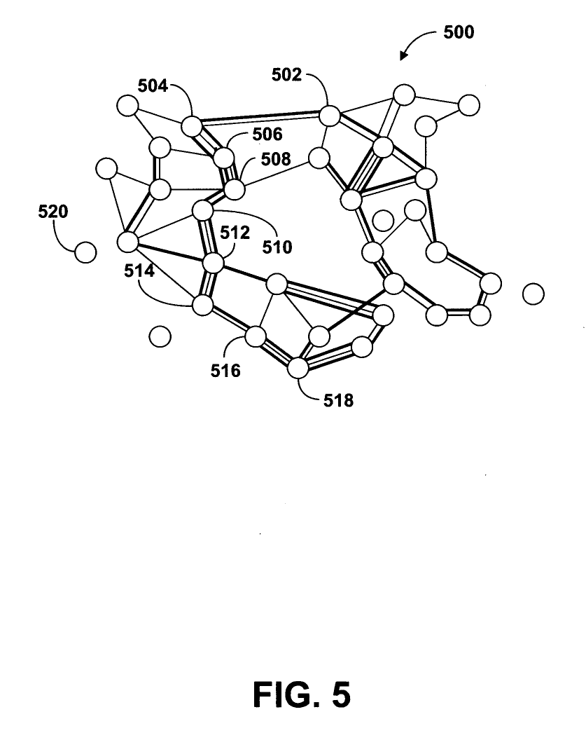

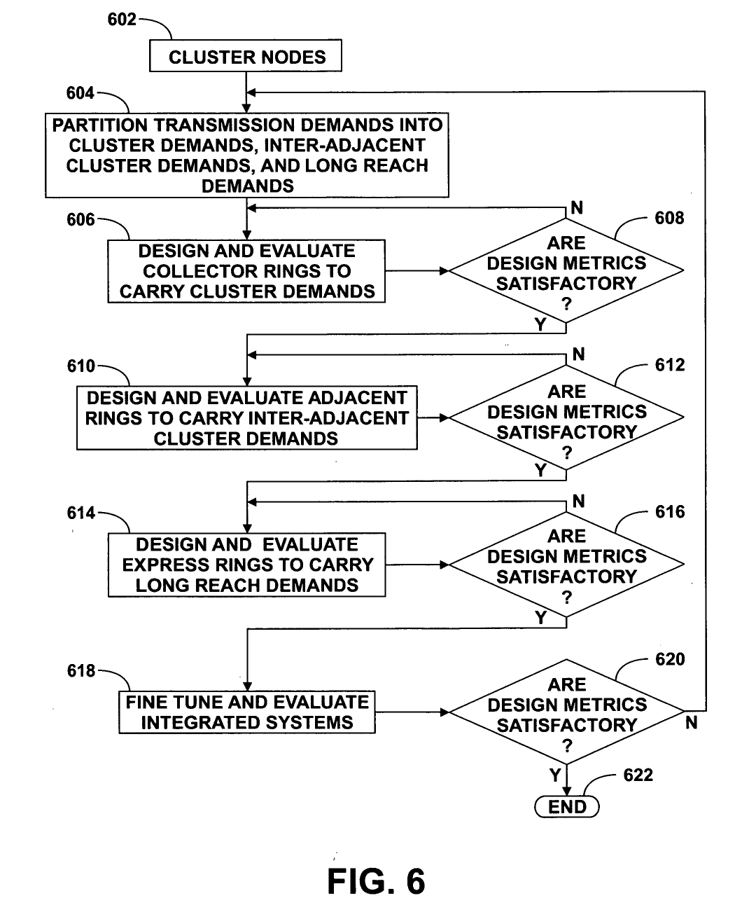

FIG. 5 depicts a possible integrated multi level synchronous optical network ring design based on some of the conditions illustrated in FIGS. 3 and 4. The ring design of FIG. 5 can be configured by the method discussed below in reference to FIG. 6. The configured system illustrated provides a multi-ring network topology having function specific rings. The method of the present disclosure can provide a ring-based design having function specific rings that will support specific partitioned demands and provide an optimized configuration for such demands. The ring set can be configured based on a predetermined community of interests between nodes in the network and the satisfactory placement of inter-ring capacities. Rings transporting a high community of interest (i.e. satisfying a large percentage of traffic within a cluster) are desirable because they minimize the amount of inter-ring traffic (i.e. traffic between rings). Minimizing inter-ring traffic improves the network survivability while minimizing hardware costs.

The optimization method described below can be based on a holistic algorithm in which a set of design metrics are utilized to obtain an optimum multi-ring topology for an entire communication system. Some of the design metrics can be given more importance in the design process. The design metrics considered to be significant in analyzing the design include a ring achievable utilization (Ur), a network survivability ratio (Sr), a cost per routed unit demand (Cᵤ), equipment cost (Ce), and overall network utilization (U). The design metrics can be embodied as follows:
Ring Achievable Utilization Uᵣ=(1/α)Nᵤₜₛ/Nₜₜₛ)
Network Survivability Ration Sᵣ=(D_{srv,r}+D_{srv, int})/Dₛᵥ
Cost per Routed Unit Demand Cᵤ=(ΣCₑ)/Dₛᵥ
Equipment Cost Cₑ=n_{adm} C_{adm}+nₚₗ Cₚₗ+nₛₜₛ Cₛₜₛ+nᵣ Cᵣ+n_{dcs} C_{dcs}
Overall Network Utilization U=(1/N)Σ(N_{uc,l}/N_{tc,l})
Where;

α=demand hop factor on a BLSR ring,

C_{adm}=installed cost of ADM (terminal),

C_{dcs}=cost of each STS-1 plug on BDCS,

Cₚₗ=cost of DS3 plug,

Cₛₜₛ=cost of STS-1 plug,

Cr=cost of regenerator or repeater,

Dₛᵥ=number of served (routed) A-Z demands,

Dsrv,int=number of inter-ring survivable A-Z demands,

Dsrv,r=number of intra ring survivable A-Z demands,

Dt=total number of A-Z demands,

n_{adm}=number of ADMs used,

npl=number of DS3 plugs used,

ndcs=number of STS-1 plugs used on BDCSs

nsts=number of STS-1 plugs used,

nr=number of regenerators or repeaters used,

Nuc,l=used capacity of link l,

Nuts=number of used Time Slots on a ring,

NL=total number of links in the network,

Ntts=total Time Slots on a ring,

Ntc,l=total capacity of link l

The design metrics can be calculated for each ring proposed in the design process and/or when an entire system configuration is formulated. In one embodiment the proposed system configuration attempts to provide a minimized inter-ring demand and provide an optimum value for other metrics such as the cost of implementing the new design.

Referring to FIG. 6, an exemplary method for achieving a cost effective, robust communication system design is provided. At block 602 nodes within a communication system are clustered. Node clustering can be performed based on factors such as the distance between nodes, fiber density or the capacity of communication lines between nodes, and physical barriers between nodes. For example, a mountain or ocean that separates two nodes in a cluster will often create unacceptable intra-cluster performance parameters in a completed design.

For large networks, a “K-means” clustering algorithm can be utilized to cluster nodes. A K-means clustering method is non-hierarchical method that can initially determine a number of nodes of the population that will be equal to the final number of clusters. The final number of clusters can be determined by utilizing nodes that are mutually farthest apart. Each node in the population can be examined and assigned to a cluster depending on the minimum distance between a cluster and the node. A “centroid” is calculated, and recalculated every time a node is added to the cluster. This adding and recalculation continues until all of the components are grouped into the final number of clusters.

Cluster sets can also be determined utilizing a “fuzzy-K means clustering procedure. Fuzzy-K means are well known in the pattern recognition arts and therefore will not be described in detail herein. For smaller networks, clustering can be done manually with close examination of the fiber network, demand pattern and geography of the area.

The A-Z transmission demands can be partitioned into function specific demands such as a cluster demand, an inter-adjacent cluster demand and a long reach demand as depicted at block 604. The cluster demand can also be considered as an intra-cluster community of interest. A set of clusters (a combination of clusters) can also be utilized to satisfy a cluster demand. Thus, the method can be very flexible as to what nodes are utilized to form a cluster and how the transmission demands are partitioned.

The inter-adjacent cluster demands can be considered as the community of interest between adjacent clusters. The long reach demand can be considered as a demand between non-adjacent clusters and generally a system for satisfying the remaining balance of the total demand.

Based on the partitions, a cluster demand can be determined and a sequence of nodes can be selected to form a collector ring or C-ring that may satisfy the demand placed on the cluster as is illustrated by block 606. One additional consideration in ring design may be to determine physical locations that may limit where rings can be built. The ring building process can be done utilizing “cycles.” A cycle is a sequence of nodes tracing a path from an origination node through intermediate nodes and back to the origination node such that no node is repeated or occurs twice in a path (except for the origination and destination node). A cycle can be viewed as a set of disjointed paths connecting nodes to form rings.

Collector, intra-cluster, or C-rings can be assembled or “built” based on the A-Z demand pattern. The configuration attempts to route all of the intra-cluster demands within the C-ring. Although this is not always possible, the goal to minimize inter-ring traffic (i.e. traffic between rings) provides many benefits. It can be advantageous to minimize the inter-ring demand because when a single inter-ring link becomes inoperable is difficult to recover from such a failure.

Design metrics are utilized to predict performance parameters on the assembled sequence of nodes forming the C-ring. As illustrated in block 608, it can be determined if the design metrics provide acceptable values or if the proposed system configuration has less than acceptable parameters based on a calculated metric. If the calculated parameters do not meet a predetermined set of objectives, then the process can revert back to block 604 where nodes can be reassembled possibly adding or deleting nodes from the cluster. If the design metrics applied to the proposed system provide satisfactory results then the process proceeds to block 606.

To determine if a conceptual design is acceptable, threshold values can be set, wherein if the calculated design metric does not satisfied the threshold value the configuration can be dropped and a new configuration can be tried again by redesigning C-rings. In one embodiment if the design metrics are marginally acceptable or within an acceptable range, the surplus collector demand can be retained and assigned to an A-ring or an E-ring in a subsequent process.

The design metrics above include calculations that are sensitive to excess inter-ring traffic. Thus, unacceptable parameter values can occur when utilizing the design metrics if excess traffic between C-rings results from a conceptual design.

Once a cycle is configured for collector rings, various combinations of nodes on the collector cycle that have an active SONET ADM or an active optical OADM can be tried to form A-rings or inter-adjacent rings as illustrated in block 610. A-rings can be configured to transport the inter-adjacent-cluster demand and the surplus collector demand as mentioned above. Any surplus inter-adjacent-cluster demand can also be reserved or set aside for E-rings in a subsequent process.

After the A-rings are configured the design metrics can again be calculated at block 612 to determine if any design metric value does not meet a predetermined objective. If calculations on the configured design do not meet a minimum metric then process can proceed back to block 610 and an A-ring configuration can be retried.

When a configuration results that provides good parameters but has left over demand to be satisfied, the left over demand can be applied to an express or E-ring. As described above after the nodes are assembled in a sequence, then design metrics can be calculated on the assembled sequence of nodes on a ring. In one embodiment if one or more design metric is below a predetermined objectives, then the nodes are assembled in a different sequence and it is again determined if the calculated design metrics are acceptable by recalculating and comparing the design metrics with a predetermined objectives. When an acceptable ring design can be determined from calculations on the inter-adjacent configuration at block 612, then an E-ring can be formed and evaluated at 614. E-rings are capable of carrying the long reach demand between non-adjacent clusters. If the network under design or evaluation is a small network, E-rings may not be needed in the design.

If the design metrics provide a satisfactory design parameters for-an E-ring at block 616 then all of the ring designs can be integrated into a single system, the system can be evaluated and the design can be “fine tuned” as illustrated by block 618. Calculations on the entire system can be made and the results checked for performance parameters at block 620. When the design metrics on the entire system are not satisfactory the process can start over from the initial process at 602 or 604. When the calculated parameters are good or satisfactory the process can end at block 622.

Although all of the design metrics disclosed above are important to create a robust design in an integrated system the network survivability ratio, achievable ring utilization of each ring and the cost per routed unit demand may provide metrics warranting increased considerations. The network survivability ration shows how robust a network is against link and node failures. The achievable ring utilization may indicate an “unused” capacity of a ring. Unused capacity may indicate an expensive system that will sit idle. The cost per unit demand may indicate whether the new design is expensive for the increased capacity that it can provide.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of designing a communication network comprising:
identifying nodes in a communication system to form at least one cluster of nodes, the communication system having a transmission demand;
partitioning the transmission demand into at least on cluster demand, at least one inter-adjacent cluster demand and at least one long reach demand;
configuring at least one collector ring to carry the at least one intra-cluster demand;
configuring at least one adjacent ring to carry the at least one inter-adjacent cluster demand;
configuring at least one express ring to carry the at least one long reach demand;
integrating the configured at least one collector ring with the configured at least one adjacent ring and the configured at least one express ring to obtain a communication system design; and
calculating design parameters for the communication system design to determine at least one performance metric.

2. The method of claim 1, further comprising utilizing a predetermined design objective to form the cluster of nodes wherein the predetermined design objective includes one of a ring achievable utilization, a network survivability ratio, a cost per routed unit demand, an equipment cost, and an overall network utilization indicator.

3. The method of claim 1, further comprising maximizing intra-cluster transmissions by choosing select nodes to create at least one collector ring having a traffic pattern that satisfies a significant intra-cluster transmission demand.

4. The method of claim 1, wherein when the cluster demand is greater than a predetermined value, reserving a portion of the cluster demand that exceeds a collector ring transmission capacity and assembling an adjacent ring to provide an inter-adjacent routing topology to address an excess collector ring transmission demand.

5. The method of claim 1, further comprising improving a survivability metric by minimizing the at least one inter ring demand.

6. The method of claim 1, further comprising assembling a long reach routing topology to address a reserved inter-adjacent transmission demand when an inter-adjacent transmission demand is greater than a predetermined value.

7. The method of claim 1, wherein the at least one cluster routing demand is considered first, the inter-adjacent cluster routing demand is considered second and the long range routing demand is considered third.

8. The method of claim 1, further comprising analyzing the at least one collector ring design and reconfiguring the at least one collector ring design when calculated design parameters do not meet a predetermined value.

9. The method of claim 1, further comprising analyzing the at least one adjacent ring design and reconfiguring the at least one adjacent ring design when calculated design parameters do not meet a predetermined value.

10. The method of claim 1, further comprising selecting nodes from the cluster of nodes to provide inter-ring traffic routing.

11. The method of claim 10, wherein routing traffic between the selected nodes provides one of an improved cost, utilization, or survivability.

12. The method of claim 1, wherein calculating the design parameters further comprises determining an achievable ring utilization and a cost per unit routed.

13. The method of claim 12, further comprising identifying a different set of nodes when one of the achievable ring utilization and the cost per unit routed does not meet a predetermined design parameter.

14. The method of claim 1, wherein the clustering is performed utilizing one of a geography, a distance, a fiber density, a fiber network and a demand pattern.

15. A system for producing a multi-ring network design comprising:
a memory configured to store parameters of a communication transport network and to store communication transport network design metrics; and
a processor configured to analyze a subset of inter-relatable nodes sequenced in a communication transport network by utilizing the stored parameters indicative of possible traffic routing between the nodes and applying the design metrics to the parameters such that equipment and interconnection data can be provided to evaluate a proposed multi-ring communication transport network having inter-ring communication and intra-ring communication.

16. The system of claim 15, further comprising evaluating one of utilization, survivability and cost of a proposed multi-ring communication transport network.

17. The system of claim 15, wherein the subset of nodes is clustered based on at least one of a distance, a fiber density interconnection, geography between nodes, and a demand pattern.

18. The system of claim 15, further comprising selecting a node on a ring for analysis of inter-ring transmission wherein the node has an add delete multiplexer.

19. The system of claim 15, further comprising evaluating the proposed network by determining one or an achievable ring utilization or a cost per unit routed demand.

20. The system of claim 15, wherein the inter-related nodes are one of an existing network and a proposed network.

21. A method of configuring a communication network comprising:
grouping nodes of a communication system to form a cluster of nodes;
partitioning transmission demands into at least one transmission demand within the cluster and at least one transmission demand between the cluster and an external node; and
determining a ring routing topology based on predetermined design criteria applied to the partitioned transmission demand.

22. The method of claim 21, wherein the predetermined design criteria is one of a ring achievable utilization, a network survivability ratio, a healing ability, a redundancy rating, a failure analysis, a cost per routed unit demand, an equipment cost, and an overall network utilization.

23. The method of claim 21, further comprising modifying the ring routing topology to minimize an inter-ring transmission.

24. The method of claim 21, further comprising determining an intra-cluster routing topology to support an intra-cluster transmission demand.

25. The method of claim 21, wherein when the determined intra-cluster transmission demand is greater than a predetermined value, assembling an inter-adjacent cluster of nodes to provide an inter-adjacent routing topology to address the partitioned transmission demand.

26. The method of claim 21, wherein when the provided inter-adjacent transmission demand is greater than a predetermined value, assembling a long reach routing topology to address the partitioned transmission demand.

27. The method of claim 21, wherein intra cluster routing is considered first, inter adjacent cluster routing is considered second and long range cluster routing is considered third.

28. The method of claim 21, further comprising simulating and analyzing an adjacent ring responsive to a demand pattern by configuring a routing topology that routes data transmissions within the collector ring.

29. The method of claim 21, further comprising determining when an intra-cluster design metric is not optimized and reconfiguring routing of transmission at nodes in the intra-cluster design.

30. The method of claim 21, further comprising routing traffic between selected nodes to improve the design metrics.

31. The method of claim 30, wherein the routing provides one of an improved cost, utilization, or survivability.

32. The method of claim 21, further comprising integrating the communication network by determining one of an achievable ring utilization or cost per unit routed.

33. The method of claim 21, wherein the partitioning further comprises partitioning the transmission demands into a cluster demand, an inter-adjacent demand and a long reach demand.

34. The method of claim 21, wherein the clustering is performed utilizing one of a geography, a distance, a fiber density, a fiber network and a demand pattern.
